(19) United States
(12) Patent Application Publication
(10) Pub. No.: US 2002/0052438 A1
(43) Pub. Date: May 2, 2002

(54) Thermoplastic resin composition for laser marking capable of forming chromatic colors

(76) Inventors: Hiroyuki Ito, Tokyo (JP); Masahiko Noro, Tokyo (JP)

Correspondence Address: NIXON & VANDERHYE P.C., 8th Floor, 1100 North Glebe Road, Arlington, VA, 22201-4714, US

(21) Appl. No.: 09/837,762

(22) Filed: Apr. 19, 2001

Related U.S. Application Data
(63) Continuation-in-part of application No. PCT/JP99/05875, filed on Oct. 25, 1999.
(63) Continuation-in-part of application No. 09/806,673, filed on Jun. 16, 2001.

(30) Foreign Application Priority Data
Oct. 26, 1998 (JP) 10-304117
Oct. 25, 1999 (JP) PCT/JP99/05875

(51) Int. Cl. C08K 3/18

(52) U.S. Cl. 524/431

(57) ABSTRACT

The present invention relates to a thermoplastic resin composition for laser marking capable of developing chromatic colors containing (A) 100 parts by weight of a thermoplastic resin comprising 1 to 100% by weight of a rubber-reinforced resin (A-1) obtained by polymerizing 95 to 30% by weight of at least one monomer (b) selected from aromatic vinyl compounds, vinyl cyanide compounds, (meth)acrylic esters, acid anhydride-based monomers and maleimide-based compounds in the presence of 5 to 70% by weight of a rubber-like polymer (a) {(a)+(b) =100% by weight}, and 99 to 0% by weight of a polymer (A-2) obtained by polymerizing at least one monomer selected aromatic vinyl compounds, vinyl cyanide compounds, (meth)acrylic esters, acid anhydride-based monomers and maleimide-based compounds. The total of (A-1)+(A-2) is 100% by weight. Polymerized (meth)acrylic ester is present in an amount of 30 to 70% by weight and the rubber-like polymer (a) is a mixture of at least two rubber-like polymers differing in particle size; (B) 0.01 to 5 parts by weight of at least one black system compound selected from black iron oxide and titanium black; and (C) 0.01 to 5 parts by weight of a dye and/or an organic pigment.

### CROSS REFERENCE TO RELATED APPLICATION

This is a continuation-in-part of application Ser. No. (unknown) (PCT/JP99/05875), filed Oct. 25, 1999 (international filing date).

### BACKGROUND OF THE INVENTION

The present invention relates to a thermoplastic resin composition for laser marking comprising a thermoplastic resin, a black system compound, and a dye and/or an organic pigment, and capable of vividly developing chromatic colors which have hitherto been unobtainable.

Laser marking is used for marking the surfaces of plastic molded articles such as electric and electronic parts, semiconductor products, etc., with letters (characters), signs and such. This laser marking is an art of forming chromatic colors by applying laser light to the surface of an article molded from a thermoplastic resin composition containing a specific black system compound to change the color of the irradiated part to black or white. Such laser marking technology is used for various purposes, for instance, for forming key letters (signs) on a keyboard, but this technology has the problem that the colors developable thereby are limited to black and white, and therefore the fields of application of this art have been restricted.

Further, there has not been obtained a thermoplastic resin composition for laser marking, which is excellent in the laser marking performance as described above, impact resistance, heat resistance and molding workability as well as a good balance of properties. Especially, there has not been obtained a thermoplastic resin composition for laser marking and used for applications, such as buttons, housings, switches, etc., to be used for OA equipment, domestic electrical appliances, vehicles, etc., and building materials such as doorsills, window frames, handrails, etc, which require high impact resistance.

As the present inventors' earnest studies to solve the above problem, it has been found that by using a thermoplastic resin composition prepared from two or more types of rubber-like polymer differing in rubber grain size, the above problem can be solved.

The present invention has been attained on the basis of the above finding.

### SUMMARY OF THE INVENTION

The object of the present invention is to provide a thermoplastic resin composition for laser marking which is capable of developing chromatic colors such as red, yellow, blue, green and purple with vividness.

The present invention provides a thermoplastic resin composition for laser marking capable of developing chromatic colors (which may hereinafter be referred to as “thermoplastic resin composition for laser marking” or simply as “thermoplastic resin composition”), comprising:

(A) 100 parts by weight of a thermoplastic resin comprising 1 to 100% by weight of a rubber-reinforced resin (A-1) obtained by polymerizing 95 to 30% by weight of at least one monomer (b) selected from the group consisting of aromatic vinyl compounds, vinyl cyanide compounds, (meth)acrylic esters, acid anhydride-based monomers and maleimide-based compounds in the presence of 5 to 70% by weight of a rubber-like polymer (a) {(a)+(b)=100% by weight}, and 99 to 0% by weight of a polymer (A-2) obtained by polymerizing at least one monomer selected from the group consisting of aromatic vinyl compounds, vinyl cyanide compounds, (meth)acrylic esters, acid anhydride-based monomers and maleimide-based compounds {(A-1)+(A-2)=100% by weight}, wherein a polymerized (meth)acrylic ester is contained in an amount of 30 to 70% by weight and the rubber-like polymer (a) is a mixture of at least two rubber-like polymers differing in particle size;

(B) 0.01 to 5 parts by weight of at least one black system compound selected from the group consisting of black iron oxide and titanium black; and

(C) 0.01 to 5 parts by weight of a dye and/or an organic pigment.

### DETAILED DESCRIPTION OF THE INVENTION

The present invention is described in detail below.

The thermoplastic resin (A) used in the present invention comprises principally a rubber-reinforced resin (A-1) or a combination of the said resin (A-1) and a polymer (A-2), and contains 30 to 70% by weight of a polymerized (meth)acrylic ester.

The said rubber-reinforced resin (A-1) is a resin obtained by polymerizing the said monomer (b) in the presence of a rubber-like polymer (a).

Examples of the rubber-like polymers (a) usable in the present invention include polybutadiene, polyisoprene, butadiene-styrene copolymer, butadiene-acrylonitrile copolymer, ethylene-propylene-(nonconjugated diene) copolymer, ethylene-butene-1-(nonconjugated diene) copolymer, isobutylene-isoprene copolymer, acrylic rubber, styrene-butadiene-styrene block copolymer, styrene-butadiene-styrene radial teleblock copolymer, styrene-isoprene-styrene block copolymer, hydrogenated diene (block, random and homo) polymers such as SEBS, polyurethane rubber and silicone rubber. Of these polymers, polybutadiene, butadiene-styrene copolymer, ethylene-propylene-(nonconjugated diene) copolymer, ethylene-butene-1-(nonconjugated diene) copolymer, hydrogenated diene polymers and silicone rubber are preferred.

In case where silicone rubber is used as the rubber-like polymer (a), if a graft crosslinking agent (such as the one containing vinyl group, γ-methacryloxypropylmethyldimethoxysilane, etc.) is contained in silicone rubber in an amount of 0.01 to 10% by weight, it is possible to obtain a thermoplastic resin composition for laser marking with excellent impact resistance.

When two or more types of rubber-like polymer (a) differing in rubber grain size are used, there can be obtained a thermoplastic resin composition having excellent impact resistance as well as a good balance of properties. As the combination of rubber-like polymers (a), there are exemplified the following two cases. First, it is preferable to use two types of rubber-like polymer (a) having grain sizes of not less than 80 and not more than 180 nm, and more than 180 and not more than 480 nm, respectively. In this case, a preferable grain sizes thereof are 120 to 180 nm and 200 to 300 nm, respectively. Second, it is preferable to use two types of rubber-like polymer (a) having grain sizes of not less than 180 and not more than 480 nm, and more than 480 and not more than 1000 nm, respectively. In this case, a preferable grain sizes thereof are 200 to 300 nm and 500 to 800 nm, respectively.

When one type of rubber-like polymer (a) is used, the resin composition may be poor in impact resistance. When two or more types of rubber-like polymer whose grain sizes are out of the above range (including the same grain size), the resin composition also may be poor in impact resistance. It is important to use two or more types of rubber-like polymer whose grain sizes are within the above range. It is especially preferable to use two types of rubber-like polymer because the properties of the obtained resin composition can be easily controlled.

In these cases, it is possible to use two or more types of rubber-reinforced resin (A-1).

The monomer (b) used in the present invention is at least one vinyl-based monomer selected from the group consisting of aromatic vinyl compounds, vinyl cyanide compounds, (meth)acrylic esters, acid anhydride-based monomers and maleimide-based compounds. Such monomers may be used either singly or by combining two or more of them.

The aromatic vinyl compounds usable as the monomer (b) include styrene, α-methylstyrene, o-methylstyrene, m-methylstyrene, p-methylstyrene, vinyltoluene, p-hydroxystyrene, α-ethylstyrene, methyl-α-methylstyrene, dimethylstyrene, brominated styrenes such as bromostyrene, dibromostyrene and tribromostyrene, chlorinated styrenes such as chlorostyrene, dichlorostyrene and trichlorostyrene, and sodium styrenesulfonate. Of these compounds, styrene, α-methylstyrene and p-methylstyrene are preferred.

Examples of the vinyl cyanide compounds usable as the monomer (b) include acrylonitrile and methacrylonitrile, acrylonitrile being preferred

The (meth)acrylic esters usable as the monomer (b) include methyl acrylate, ethyl acrylate, butyl acrylate, methyl methacrylatle, ethyl methacrylate and butyl methacrylate. Among them, methyl methacrylate and butyl acrylate are preferred. This (meth)acrylic ester is a component essential for color development in laser marking according to the present invention. Its amount used for the polymerization is 30 to 70% by weight based on the thermoplastic resin (A) as explained later.

A typical example of the acid anhydride-based monomers usable as the monomer (b) is maleic anhydride.

The maleimide-based compounds usable as the monomer (b) include maleimide, N-methylmaleimide, N-ethylmaleimide, N-propylmaleimide, N-isopropylmaleimide, N-laurylmaleimide, N-phenylmaleimide, N-(2-methylphenyl)maleimide, N-(2,6-diethylphenyl)maleimide, N-(4-carboxyphenyl)maleimide, N-(4-hydroxyphenyl)maleimide, N-(4-bromophenyl)maleimide, tribromophenylmaleimide, N-(4-chlorophenyl)maleimide and N-cyclohexylmaleimide. Of these compounds, N-phenylmaleimide is preferred. When a maleimide-based compound such as mentioned above is copolymerized in an amount of 30 to 60% by weight in the monomer (b), heat resistance of the thermoplastic resin composition for laser marking of the present invention is improved. It should be noted, however, that if the content of such a maleimide-based compound exceeds 60% by weight, the quality of laser marking may be degraded.

The amount of the rubber-like polymer (a) and the amount of the monomer (b) to be supplied for the graft polymerization is: 5 to 70% by weight, preferably 20 to 60% by weight, more preferably 30 to 65% by weight for (a), and 95 to 30% by weight, preferably 80 to 40% by weight, more preferably 70 to 35% by weight for (b) {(a)+(b)=100% by weight}. When the amount of (a) is less than 5% by weight, no satisfactory impact resistance may be provided, and when it exceeds 70% by weight, there tends to result poor appearance of the composition or deterioration of molding workability.

The graft ratio of the rubber-reinforced resin (A-1) is preferably 10 to 150% by weight, more preferably 30 to 130% by weight, even more preferably 40 to 120% by weight. If this ratio is less than 10% by weight, the obtained thermoplastic resin composition may be unsatisfactory in appearance and impact strength. If the ratio exceeds 150% by weight, the composition may be degraded in molding workability.

The above graft ratio (%) is given by the following equation:

Graft ratio (%)={(y−x)/x}×100

wherein x is the amount of rubber present in 1 g of the resin (A-1), and y is the amount of methyl ethyl ketone insolubles present in 1 g of the resin (A-1).

The intrinsic viscosity [η] (measured in methyl ethyl ketone at 30° C.) of the matrix resin of the rubber-reinforced resin (A-1) is preferably 0.1 to 1.0 dl/g, more preferably 0.3 to 0.9 dl/g. When the intrinsic viscosity [η] is within the above-defined range, it is possible to obtain the thermoplastic resin composition of the present invention with excellent impact strength and molding workability (fluidity).

Here, “matrix resin” means the resin material other than the grafted rubber in the resin (A-1), and the intrinsic viscosity [η] shown here is the value determined by measuring the amount of methyl ethyl ketone solubles in the component (A-1) by a conventional method.

The polymer (A-2) used in the present invention is a polymer obtained by polymerizing at least one monomer selected from the group consisting of aromatic vinyl compounds, vinyl cyanide compounds, (meth)acrylic esters, acid anhydride-based monomers and maleimide-based compounds, all of which may be the same as those mentioned above as the monomer (b) for the rubber-reinforced resin (A-1).

The intrinsic viscosity [η] of the polymer (A-2) (measured in methyl ethyl ketone at 30° C.) is preferably 0.1 to 1.0 dl/g, more preferably 0.3 to 0.9 dl/g. When the intrinsic viscosity [η] is within the above-defined range, there can be obtained the thermoplastic resin composition of the present invention with excellent impact resistance and molding workability (fluidity).

The rubber-reinforced resin (A-1) can be obtained by the various methods, for example: (1) Polymer (b) is polymerized in the presence of rubber-like polymer (a); (2) Part of monomer (b) is polymerized in the presence of rubber-like polymer (a), with the remainder of monomer (b) being polymerized separately, and these two portions are blended together (graft blending method).

The polymer (A-2) can be obtained by, for example, a method (3) which is the same as the above method (1) or (2) except that no rubber-like polymer (a) is used.

Known polymerization methods such as emulsion polymerization, solution polymerization and suspension polymerization can be used for the polymerization conducted in the preparation of rubber-reinforced resin (A-1) and polymer (A-2), but in case where emulsion polymerization is used, usually the polymerization product is purified by solidifying it with a solidifying agent and washing with water and then drying the obtained powder. As the solidifying agent, inorganic salts such as calcium chloride, magnesium sulfate, magnesium chloride and sodium chloride can be used.

As the radical polymerization initiator, it is possible to use those commonly used in the art, such as cumene hydroperoxide, diisopropylbenzene hydroperoxide, potassium persulfate, azobisisobutyronitrile (AIBN), benzoyl peroxide, lauroyl peroxide, t-butyl peroxylaurate, and t-butyl peroxymonocarbonate.

Representative examples of the rubber-reinforced resin (A-1) are ABS resin, AES resin, ASA resin (polymer obtained by grafting AS resin to acrylic rubber) and ASS resin (polymer obtained by grafting AS resin to silicone rubber).

Representative examples of the polymer (A-2) are AS resin, styrene-acrylonitirle-methyl methacrylate (ST-AN-MMA) copolymer, styrene-methyl methacrylate (ST-MMA) copolymer, styrene-N-phenylmaleimide copolymer, polystyrene, and polymethyl methacrylate (PMMA). Of these polymers, AS resin, ST-AN-MMA resin and PMMA resin are preferred, especially, ST-AN-MMA resin and PMMA resin being preferred.

In case of using ABS resin or AES resin as the rubber-reinforced resin (A-1) in the present invention, the preferred rubber content in the resin is 10 to 65% by weight, more preferably 25 to 55% by weight, the preferred graft ratio is 40 to 150% by weight, more preferably 50 to 120% by weight, and the preferred intrinsic viscosity [η] of the matrix resin is 0.1 to 0.8 dl/g.

In case of using AS resin as the polymer (A-2), the preferred amount of acrylonitrile to be copolymerized is 15 to 35% by weight, more preferably 18 to 32% by weight, especially preferably 20 to 31% by weight, and the preferred intrinsic viscosity [η] is 0.3 to 1.0 dl/g, more preferably 0.4 to 0.7 dl/g.

In the case of AS resin in which methyl methacrylate (MMA) is copolymerized (ST-AN-MMA copolymer), the preferred amount of MMA to be copolymerized is 30 to 80% by weight, more preferably 35 to 65% by weight, and the preferred intrinsic viscosity [η] is 0.3 to 0.8 dl/g, more preferably 0.4 to 0.8 dl/g.

It is also preferable to properly use polymethyl methacrylate (PMMA) as the polymer (A-2).

A functional group-containing vinyl-based monomer may be further copolymerized in the preparation of the rubber-reinforced resin (A-1) or polymer (A-2). The functional group to be contained in this monomer may be, for instance, epoxy, hydroxyl, carboxyl, amino, amide or oxazoline. As typical examples of such functional group-containing vinyl-based monomers, glycidyl methacrylate, glycidyl acrylate, 2-hydroxyethyl methacrylate, 2-hydroxyethyl acrylate, acrylic acid, methacrylic acid, acrylamide and vinyloxazoline can be mentioned. By copolymerizing such a functional group-containing vinyl-based monomer, it is possible to enhance interfacial adhesion (compatibility) with other polymers. The amount of such a functional group-containing vinyl-based monomer to be copolymerized is preferably 0.1 to 15% by weight, more preferably 0.5 to 12% by weight, in (A-1) or (A-2).

The thermoplastic resin (A) according to the present invention comprises principally the said rubber-reinforced resin (A-1) or a blend of this resin (A-1) and the said polymer (A-2).

As for the blending ratios of the rubber-reinforced resin (A-1) and the polymer (A-2), the percentage of (A-1) is usually 1 to 100% by weight, preferably 5 to 60% by weight, more preferably 10 to 50% by weight, and the percentage of (A-2) is usually 99 to 0% by weight, preferably 95 to 40% by weight, more preferably 90 to 50% by weight {(A-1)+(A-2)=100% by weight}. When the percentage of (A-1) is less than 1% by weight, the obtained composition may be unsatisfactory in impact resistance.

The amount of the polymerized (meth)acrylic ester contained in the thermoplastic resin (A) of the present invention is 30 to 70% by weight, preferably 33 to 60% by weight, more preferably 35 to 55% by weight. When the content of the polymerized (meth)acrylic ester is less than 30% by weight, color development of laser marking may be poor and the composition is unsuited for forming chromatic colors. When the amount of this ester exceeds 70% by weight, impact resistance of the composition may be deteriorated.

Examples of the preferred combinations of the components of the thermoplastic resin (A) are shown below. It should be understood, however, that the scope of the claim of the present invention is not restricted to the following examples.

(1) ABS resin in which methyl methacrylate has been copolymerized.

(2) ABS resin/methyl methacrylate-copolymerized AS resin (MMA-ST-AN copolymer)

(3) AES resin/methyl methacrylate-copolymerized AS resin (MMA-ST-AN copolymer)

(4) ABS resin/AS resin/PMMA

(5) AES resin/AS resin/PPMA

(6) Polyorganosiloxane-reinforced resin (obtained by graft polymerizing AS resin to silicone rubber)/methyl methacrylate-copolymerized AS resin (MMA-ST-AN copolymer)/PMMA

The component (B) used in the present invention is at least one black system compound selected from the group consisting of carbon black, black iron oxide and titanium black. Carbon black is especially preferred. Graphite may be added to the component (B), if required.

When the component (B) is represented by a wavelength-reflectance curve, its reflectance should not be more than 10%, preferably not more than 5%, over the whole wavelength region of 400 to 700 nm. That is, the component (B) is a compound which absorbs light of the wavelength in the range of 400 to 700 nm.

Various types of carbon black such as acetylene black, channel black and furnace black can be used as the component (B). The preferred particle size of such carbon black is 10 to 80 nm, more preferably 12 to 40 nm. The smaller the particle size, the better is dispersability in the resin, hence better color development of laser marking. Also, carbon black used as the component (B) preferably has a specific surface area of 20 to 1,500 m²/g, an oil absorption of 35 to 300 ml/100 g, and a pH of 2 to 10.

The black iron oxides usable as the component (B) are those represented by Fe₃O₄ and FeO.Fe₂O₃. These black iron oxides are of a particle size of preferably 0.3 to 0.8 μm, more preferably 0.4 to 0.6 μm, and they may assume various shapes such as spherical, cubic, needle-like, etc., but cubic form is preferable.

Titanium black usable as the component (B) is a compound obtained by reducing titanium dioxide. Such titanium black is preferably of a particle size of 0.1 to 60 μm, more preferably 1 to 20 μm.

The component (C) of the composition of the present invention is a dye and/or an organic pigment. When the component (C) is represented by a wavelength-reflectance curve, its reflectance partially is in the region of preferably not less than 40%, more preferably 50 to 100%, in the wavelength region of 400 to 700 nm.

The thermoplastic resin composition for laser marking according to the present invention is characterized by its capability to develop chromatic colors such as yellow, red, blue, green and purple with remarkable vividness. That is, basically the color of the dye and/or the organic pigment contained in the composition is developed at the part exposed to laser light.

The dyes usable as the component (C) in the present invention include nitroso dye, nitro dye, azo dye, stilbeneazo dye, ketoimine dye, triphenylmethane dye, xanthene dye, acridine dye, quinoline dye, methine dye, thiazole dye, indamine dye, azine dye, oxazine dye, thiazine dye, sulfide dye, aminoketone dye, anthraquinone dye, and indigoid dye.

Concrete examples of these dyes are Mordant Green 4, Disperse Yellow 14, Disperse Yellow 31, Acid Yellow 2, Direct Yellow 59, Basic Yellow 2, Basic Orange 23, Direct Orange 71, Direct Red 28, Acid Red 52, Solvent Blue 22, Acid Blue 59, Mordant Blue 10, Acid Blue 45, Vat Blue 41, Toluidine Maroon, Permanent Red AG, Hansa Yellow G, Hansa Yellow 10G and Benzidine Orange 2G.

As the organic pigment in the component (C), it is possible to use those generally used in the art, especially ones in which the coordinated metal is calcium, nickel, iron, barium, sodium, copper, molybdenum, cobalt, manganese, zinc, titanium, magnesium, potassium or the like.

Concrete examples of these organic pigments are Watching Red (Ca), Green Gold (Ni), Pigment Green B (Fe), Pigment Scarlet 3B (Ba), Fast Sky Blue (Ba), Phthalocyanine Green (Fe), Phthalocyanine Blue (Cu), Brilliant Carmine 6B (Ca), Bordeaux 10B (Na), Lithol Red R (Na), Lake Red D (Na), Brilliant Scarlet G (Ca), Manganese Violet (Mn) and Cobalt Violet (Co). The elements contained in these organic pigments are shown in the parentheses after the names of the pigments.

The mechanism of developing chromatic colors by the thermoplastic resin composition according to the present invention is yet to be elucidated, but the following explanation appears trustworthy. In case where, for instance, the black system compound, or component (B), blended in the thermoplastic resin (A) is carbon black, it absorbs laser light applied to the composition, with the result that carbon black existing at the irradiated part is gasified. At this stage, blackness at the irradiated part is eliminated or lessened.

On the other hand, the component (C) having a chromatic color, which has been present at the irradiated part, remains unchanged as it does not absorb laser light, and develops its innate chromatic color at the irradiated part.

Another explanation of the above mechanism is as follows. The component (B), such as carbon black, black iron oxide or titanium black, absorbs laser light and converts light into heat, and the generated heat decomposes and expands the (meth)acrylic ester in the thermoplastic resin composition. Since the refractive index differs between the expanded part and the non-irradiated part, blackness does not come out but the innate chromatic color of the component (C) is developed. As will be understood from the above color developing mechanism, it is essential that the component (B) absorbs laser light while the component (C) does not absorb laser light of the specified wavelength. Titanium black, when oxidized by exposure to light, assumes the white color of titanium dioxide, so that the innate color of the component (C) existing at this part becomes recognizable.

As for the ratios of the components (A) to (C) in the thermoplastic resin composition for laser marking according to the present invention, when the ratio of the thermoplastic resin (A) is supposed to be 100 parts by weight, the ratio of the component (B) is 0.01 to 5 parts by weight, preferably 0.02 to 3 parts by weight, more preferably 0.03 to 2 parts by weight, especially 0.04 to 1 part by weight, and the ratio of the component (C) is 0.01 to 5 parts by weight, preferably 0.02 to 3 parts by weight, more preferably 0.03 to 2 parts by weight, especially 0.04 to 1 part by weight.

When the ratio of the component (B) is less than 0.01 part by weight, color development of laser marking may be poor, and when its ratio exceeds 5 parts by weight, there also result poor color development of laser marking and poor impact resistance. The similar results are observed when the ratio of the component (C) is less than 0.01 part by weight or exceeds 5 parts by weight.

Generally, the smaller the amount of the components (B) and (C), the better quality of laser marking can be obtained.

By applying laser light to the surface of a molded article of the thermoplastic resin composition according to the present invention, it is possible to develop the chromatic colors vividly at the irradiated part. As the source of such laser light, there can be used gaseous laser such as He—Ne laser, Ar laser, CO₂ laser and excimer laser, solid laser such as YAG laser, semiconductor laser, dye laser, etc. Of these types of laser, CO₂ laser, excimer laser and YAG laser are preferred. The wavelength of YAG laser light is 1,054 nm.

When laser light is applied to the surface of a molded article of the thermoplastic resin composition of the present invention, usually the irradiated part rises up slightly above the non-irradiated part. The height of such rise-up of the irradiated part is preferably about 1 to 100 μm, but about 10 to 80 μm of rise-up is more preferable for allowing clear cognizance of color development of laser marking and the irradiated (letter) part. It is also possible to make use of such raised letters for producing the moldings for braille.

In the thermoplastic resin composition of the present invention, one or more fillers such as glass fiber, carbon fiber, wollastonite, talc, mica, glass flake, mild fiber, zinc oxide whisker, potassium titanate whister, etc., may be contained as desired. Presence of such filler(s) in the composition provides rigidity to the composition. Also, blending of talc gives a matte effect to the composition. The preferred configuration of glass fiber or carbon fiber used as filler is 6 to 20 μm in diameter and not less than 30 μm in length.

The amount of such a filler or fillers blended is preferably 1 to 50 parts by weight, more preferably 2 to 30 parts by weight, based on 100 parts by weight of the thermoplastic resin (A). When the amount of filler(s) exceeds 50 parts by weight, the quality of laser marking by the composition may be deteriorated.

In the composition of the present invention, it is also possible to blend the commonly used additives such as coupling agent, weathering agent, antioxidant, plasticizer, lubricant, colorant other than the components (B) and (C), antistatic agent, silicone oil, etc.

As the weathering agent, the phosphorus- or sulfur-based organic compounds and the organic compounds containing hydroxyl groups are preferably used. As the antistatic agent, polyesters, sulfonates having alkyl groups and the like can be used. Such additives are contained in an amount of preferably 0.1 to 10 parts by weight, more preferably 0.5 to 5 parts by weight based on 100 parts by weight of the thermoplastic resin (A).

Further, where necessary, other polymers such as other types of thermoplastic or thermosetting resins may be blended in the composition of the present invention.

Examples of other polymers that can be blended in the composition of the present invention include polycarbonates, polyethylenes, polypropylenes, polyamides, polyesters, polysulfones, polyether sulfones, polyphenylene sulfide, liquid crystal polymers, polyvinylidene fluoride, polytetrafluoroethylene, styrene-vinyl acetate copolymer, polyamide elastomers, polyamide-imide elastomers, polyester elastomers, polyether ester amides, phenol resins, epoxy resins, and novolak resins. It is notable that blending of polyamides, polyethylenes, polypropylenes and the like contributes to making the color development in laser marking more vivid.

The amount of such other polymer(s) to be blended is preferably 1 to 150 parts by weight, more preferably 5 to 100 parts by weight based on 100 parts by weight of the thermoplastic resin (A).

Blending of polyamide elastomers, polyether ester amides and such can impart permanent antistatic properties to the composition. These polymers are contained in an amount of preferably 1 to 30 parts by weight, more preferably 2 to 20 parts by weight based on 100 parts by weight of the thermoplastic resin (A).

It is also possible to blend a flame-retardant for imparting flame retardancy to the composition. As the flame-retardant, halogenous compounds, organic phosphorus-based compounds, nitrogen-based compounds, metal hydroxide compounds, antimony compounds and the like can be used either singly or as a combination.

Examples of the halogenous compounds include tetrabromobisphenol A, oligomers of tetrabromobisphenol A (which may be capped with epoxy group, tribromophenol or such at the terminal of the molecular chain), brominated polystyrenes, after-brominated polystyrenes, brominated polycarbonate oligomers, tetrabromobisphenol A, tribromophenoxyethane, chlorinated polystyrenes and aliphatic chlorine compounds. Of these compounds, oligomers of tetrabromobisphenol A are preferred (preferable molecular weight being about 1,000 to 6,000). The concentration of halogen atom such as bromine in the halogenous compounds is preferably 30 to 65% by weight, more preferably 45 to 60% by weight.

Examples of the organic phosphorus-based compounds include triphenyl phosphate, trixylenyl phosphate, tricredyl phosphate, trixylenyl thiophosphate, hydroquinonebis(diphenyl phosphate), resorcinolbis(diphenyl phosphate), resorcinylbis(dixylenyl phosphate), and oligomers of triphenyl phosphate. Of these compounds, triphenyl phosphate, trixylenyl phosphate and resorcinolbis(xylenyl phosphate) are preferred. The preferred phosphorus concentration in such organic phosphorus-based compounds is 4 to 30% by weight, more preferably 6 to 25% by weight.

Examples of the nitrogen-based compounds are triazine and melamine.

Magnesium hydroxide and aluminum hydroxide can be exemplified as the metal hydroxide compounds.

Antimony trioxide and antimony pentoxide can be exemplified as the antimony compounds.

The amount of the flame-retardant to be blended is preferably 1 to 50 parts by weight, more preferably 2 to 30 parts by weight, even more preferably 5 to 25 parts by weight, based on 100 parts by weight of the thermoplastic resin (A). When the amount of the flame-retardant blended is less than 1 part by weight, its effect of providing flame retardancy to the composition may be unsatisfactory, and when its amount exceeds 50 parts by weight, the composition may be degraded in impact resistance and laser marking performance.

The thermoplastic resin composition for laser marking according to the present invention can be obtained by kneading the component materials at a temperature in the range of 160 to 300° C. by a suitable means such as extruder, Banbury mixer, kneader, roll mill, etc. Kneading can be accomplished either by mixing and kneading all of the component materials in one lot or by a multi-stage separate kneading method in which certain component materials are kneaded first and then the remaining materials are added and kneaded together. The method using an extruder, especially a turning-in-one-direction double-screw extruder is preferred.

For preparing the thermoplastic resin composition for laser marking according to the present invention, it is possible to use a method in which initially the components (A-1) and (A-2) are blended, and then the components (B) and (C) are melted and kneaded therewith, or a method in which all of the components (A-1), (A-2), (B) and (C) are melted and kneaded all together simultaneously or in multiple stages at optional rates.

The resin composition for laser marking according to the present invention can be molded into various types of articles by known molding methods such as injection molding, sheet-extrusion molding, vacuum forming, contour extrusion, foam molding, etc. By these molding methods, it is possible to obtain various molded articles such as buttons, housings, switches, etc., to be used for OA equipment, household electrical appliances, vehicles, etc. The composition of the present invention can also be applied to building materials such as doorsills, window frames, handrails, etc.

By applying laser light to the surfaces of these articles, it is possible to develop chromatic colors with vividness.

Further, the color-developed letter part formed by laser marking excels the printed letter part in weather and wear resistance, so that laser marking is practically far advantageous over printing.

The composition for laser marking according to the present invention described above is capable of vividly developing chromatic colors such as red, yellow, blue, green and purple when exposed to laser light, and also excels in impact resistance, heat resistance, molding workability, etc., so that it can be used for many applications, such as buttons, housings, switches, etc., to be used for OA equipment, domestic electrical appliances, vehicles, etc., and building materials such as doorsills, window frames, handrails, etc.

### EXAMPLES

The present invention will be explained in further detail by showing examples thereof, but it should be understood that these examples are merely intended to be illustrative and not to be construed as limiting the scope of the invention in any way.

In the following Examples, all “parts” and “%” are by weight unless otherwise noted.

The various determinations in the Examples were conducted by the methods described below.

(a) Average Particle Size

As it was confirmed by electron microscopical observation that the particle sizes of the latex synthesized in an emulsified state are equal to the sizes of the dispersed particles in the resin, the sizes (diameters) of the dispersed particles in the latex were measured by the light scattering method using a particle size meter LPA-3100 (mfd. By Otsuka Denshi KK). A 70-integration cumulant system was used for the measurement.

(b) Graft Ratio

1 g of sample was weighed out accurately, and 20 cc of acetone was added thereto. The solution was shaken for 10 hours and then centrifuged at 20,000 rpm to separate the solubles from the insolubles, and the insolubles were dried by a vacuum dryer to obtain insoluble matter (X). The rubber content (R) in the insoluble matter (X) was calculated from the polymerization composition and the polymerization conversion, and the graft ratio (%) was determined from the following equation.

Graft ratio (%)={(X)−(R)}100/(R)

(c) Intrinsic viscosity [η]

In the case of the rubber-reinforced resin (A-1), the said soluble matter dried by a vacuum dryer, and in the case of the polymer (A-2), the sample as it is, was dissolved in the solvent methyl ethyl ketone and their intrinsic viscosity was measured at 30° C. by an Ubbellohde viscometer.

(d) Izod Impact Strength (IMP)

Determined according to ASTM D256 using a notched ¼ thick test piece at 23° C.

(e) Fluidity (Melt Flow Rate)

Determined according to ASTM at 220° C. under a load of 10 kg.

(f) Thermal Deformation Temperature

Determined according to ASTM D648.

(g) Laser Marking Performance

A plate-like molding was formed from the thermoplastic resin composition of this invention by injection molding, and laser marking was conducted on the surface of the molding by a laser marker (Star Mark) 65W using YAG laser, mfd. by Carl Baasel Co., Ltd.

The state of color development, recognizability and vividness of the part where color was developed by application of laser light were visually judged as follows.

A: Excellent (Vivid and well recognizable letters were formed with colors other than white and black)

B: Good (Letters formed with colors other than white and black were poor either in vividness or in recognizability)

C: Poor (Both vividness and recognizability were poor)

(h) Letter Color

In the rating of letter color, “C” indicates white or black.

### Examples 1-7 and Comparative Examples 1-10

(1) Preparation of Rubber-reinforced Resin

<(A)-1-(1) (Preparation of Rubber-reinforced Resin (ABS Resin))>

100 parts of ion exchange water, 1.5 part of sodium dodecylbenzenesulfonate, 0.1 part of t-dodecylmercaptan, 40 parts (calcd. as solid) of polybutadiene (a) latex having an average particle size of 180 nm, 15 parts of styrene and 5 parts of acrylonitrile were supplied to a 7-liter glass-made flask equipped with a stirrer, and heated with stirring. At the point when the temperature reached 45° C., an aqueous activator solution comprising 0.1 part of sodium ethylenediaminetetracetate, 0.003 part of ferrous sulfate, 0.2 part of formaldehyde sodium sulfoxylate dihydrate and 15 parts of ion exchange water, and 0.1 part of diisopropylbenzene hydroperoxide were added, and the reaction was continued for one hour.

Then, incremental polymerization materials comprising 50 parts of ion exchange water, 1 part of sodium dodecylbenzenesulfonate, 0.1 part of t-dodecylmercaptan, 0.2 part of diisopropyl hydroperoxide, 30 parts of styrene and 10 parts of acrylonitrile were added continuously over the period of 3 hours, keeping on the polymerization reaction. After the end of the addition, stirring was further continued for one hour, then 0.2 part of 2,2-methylenebis(4-ethylene-6-t-butylphenol) was added and the reaction product was taken out of the flask. The reaction product latex was solidified with 2 parts of calcium chloride, washed well with water and dried at 75° C. for 24 hours to obtain a white powder.

Polymerization conversion was 97.2%, graft ratio was 75%, and intrinsic viscosity of the product was 0.44 dl/g.

<(A)-1-(2) (Preparation of Rubber-reinforced Resin (MMA-copolymerized ABS Resin))>

By using a polybutadiene (a) latex having an average particle size of 270 nm, an MMA-copolymerized ABS resin (A-1-(ii)) was prepared in the same way as described above. This resin had the composition of: polybutadiene/styrene/methyl methacrylate/acrylonitrile=15/20/60/5(%).

<(A)-1-(3) (Preparation of Rubber-reinforced Resin (MMA-copolymerized ABS Resin))>

By using a polybutadiene (a) latex having an average particle size of 180 nm, an MMA-copolymerized ABS resin (A-1-(iii)) was prepared in the same way as described above. This resin had the composition of: polybutadiene/styrene/methyl methacrylate/acrylonitrile=15/20/60/5(%).

<(A)-1-(4) (Preparation of Rubber-reinforced Resin (ABS Resin))>

By using 32 parts (based on solid parts) of a polybutadiene (a) latex having an average particle size of 270 nm and 8 parts (based on solid parts) of a polybutadiene (a) latex having an average particle size of 650 nm, an ABS resin (A-1-(iv)) was prepared in the same way as described above. This resin had the composition of: polybutadiene/styrene/acrylonitrile=40/45/15(%)

(2) Preparation of Polymer (A-2)

<A-2-(1) (AS Resin)>

Composition: styrene/acrylonitrile=73/27(%)

Intrinsic viscosity: 0.50 dl/g

<A-2-(2) (Methyl Methacrylate-containing Resin)>

Composition: styrene/acrylonitrile/MMA=60/5/35(%)

Intrinsic viscosity: 0.40 dl/g

<A-2-(3) (PMMA)>

Intrinsic viscosity: 0.45 dl/g

(3) Preparation of Component (B)

B-1: carbon black

B-2: black iron oxide

B-3: titanium black

(4) Preparation of Component (C)

C-1: Mordant Green 4

C-2: Direct Yellow 31

C-3: Direct Red 28

C-4: Pigment Green B

C-5: Pigment Scarlet 3B

C-6: Cobalt Violet

C-7: Phthalocyanine Blue

C-8: Direct Orange 71

(5) Preparation of Other Components

<Preparation of Other Polymers>

Polyether ester amide: nylon 6 block/polyethylene oxide block=50/50(%)

Polytetrafluoroethylene (PTFE): TF1620 by Hoechst Co., Ltd.

<Flame-retardant>

Tetrabromobisphenol A oligomer: the end of the molecular chain capped with tribromophenol; bromine concentration=56%; molecular weight=ca. 2,000

Antimony trioxide: PATOX-M by Nihon Seiko Co., Ltd.

Preparation of Thermoplastic Resin Composition

Components (A) to (C), together with other polymer(s) and additives, were melted and kneaded by an extruder at 220 to 240° C. at the rates shown in Tables 1-3, and injection molded to obtain the samples for evaluation.

Examples of the present invention are shown in Table 1. Any of the samples of thermoplastic resin composition in these Examples developed vivid chromatic colors to obtain high rating in laser marking performance and also showed sufficient impact resistance to stand practical use.

The ground color was black in each sample of thermoplastic resin composition.

Comparative Examples are shown in Table 2. In Comparative Example 1 in which the contents of the components (B) and (C) of the present invention were outside the ranges specified in the present invention, there could not be obtained good laser marking performance. In Comparative Examples 2 and 3 where either the component (B) or the component (C) of the present invention was not contained, it was impossible to obtain the chromatic colors envisaged to provide in the present invention. Comparative Example 4 is the case where the amount of the methacrylic ester in the component (A) was below the range specified in the present invention. No vivid laser marking could be obtained in Comparative example 4. In Comparative Example 5 where the component (A-1) was not contained, the composition was poor in impact resistance.

In Comparative Examples 6-9 where one type of rubber-like polymer was used and in Comparative Examples 10 where two types of rubber-like polymer having the same grain sizes were used, the compositions were poor in impact resistance.

TABLE 1

| Example No. | | 1 | 2 | 3 | 4 |
|---|---|---|---|---|---|
| Formulation (parts) | | | | | |
| (A); | A-1-(1) (ABS) | 30 | 30 | 30 | 30 |
| | A-1-(2) (MBS) | 70 | 70 | 70 | — |
| | A-1-(3) (MBS) | — | — | — | — |
| | A-1-(4) (ABS) | — | — | — | — |
| | A-2-(1) (AS) | — | — | — | — |
| | A-2-(2) (MMA-ST-AN) | — | — | — | — |
| | A-2-(3) (PNMA) | — | — | — | — |
| (Meth)acrylic ester content | | 42 | 42 | 42 | 42 |
| in component (A) (%) | | | | | |
| (B); | B-1 | 0.2 | 0.4 | 0.2 | 0.5 |
| | B-2 | — | — | — | — |
| | B-3 | — | — | 0.1 | — |
| (C); | C-1 | 0.3 | — | — | — |
| | C-2 | — | 0.3 | — | — |
| | C-3 | — | — | 0.3 | — |
| | C-4 | — | — | — | — |
| | C-5 | — | — | — | — |
| | C-6 | — | — | — | 0.3 |
| | C-7 | — | — | — | — |
| | C-8 | — | — | — | — |
| Other polymer | | | | | |
| Polyether ester amide | | — | — | — | 20 |
| PTFE | | | | | |
| Flame-retardant | | | | | |
| Tetrabromobisphenol A | | — | — | — | — |
| oligomer | | | | | |
| Antimony trioxide | | — | — | — | — |
| Evaluation of thermoplastic | | | | | |
| resin composition | | | | | |
| Izod impact strength (J/m) | | 196 | 196 | 196 | 216 |
| Fluidity (g/10 min.) | | 20 | 21 | 20 | 28 |
| Thermal deformation | | 89 | 89 | 90 | 85 |
| temperature (° C.) | | | | | |
| Laser marking performance | | A | A | A | A |
| Letter color | | Green | Yellow | Red | Violet |
| Example No. | | 5 | 6 | 7 | |
| Formulation (parts) | | | | | |
| (A); | A-1-(1) (ABS) | 30 | 30 | 30 | |
| | A-1-(2) (MBS) | 70 | 70 | — | |
| | A-1-(3) (MBS) | — | — | — | |
| | A-1-(4) (ABS) | — | — | — | |
| | A-2-(1) (AS) | — | — | — | |
| | A-2-(2) (MMA-ST-AN) | — | — | — | |
| | A-2-(3) (PNMA) | — | — | — | |
| (Meth)acrylic ester content | | 42 | 42 | 42 | |
| in component (A) (%) | | | | | |
| (B); | B-1 | 0.3 | 0.2 | 0.4 | |
| | B-2 | — | — | — | |
| | B-3 | 0.2 | — | — | |
| (C); | C-1 | — | 0.3 | — | |
| | C-2 | — | — | 0.3 | |
| | C-3 | — | — | — | |
| | C-4 | — | — | — | |
| | C-5 | — | — | — | |
| | C-6 | — | — | — | |
| | C-7 | 0.2 | — | — | |
| | C-8 | — | — | — | |

| | | | |
|---|---|---|---|
| Other polymer | | | |
| Polyether ester amide | — | — | — |
| PTFE | — | 0.2 | — |
| Flame-retardant | | | |
| Tetrabromobisphenol A | — | 20 | — |
| oligomer | | | |
| Antimony trioxide | — | 8 | — |
| Evaluation of thermoplastic | | | |
| resin composition | | | |
| Izod impact strength (J/m) | 166 | 196 | 196 |
| Fluidity (g/10 min.) | 30 | 20 | 21 |
| Thermal deformation | 86 | 89 | 89 |
| temperature (° C.) | | | |
| Laser marking performance | A | A | A |
| Letter color | Blue | Green | Yellow |

TABLE 2

| Comparative Example No. | | 1 | 2 | 3 | 4 |
|---|---|---|---|---|---|
| Formulation (parts) | | | | | |
| (A); | A-1-(1) (ABS) | 30 | 30 | 30 | 40 |
| | A-1-(2) (MBS) | 70 | 70 | 70 | — |
| | A-1-(3) (MBS) | — | — | — | 40 |
| | A-1-(4) (ABS) | — | — | — | — |
| | A-2-(1) (AS) | — | — | — | 40 |
| | A-2-(2) (MMA-ST-AN) | — | — | — | — |
| | A-2-(3) (PNMA) | — | — | — | 20 |
| (Meth)acrylic ester content | | 42 | 42 | 42 | 20 |
| in component (A) (%) | | | | | |
| (B); | B-1 | 8 | 0.7 | — | 0.5 |
| | B-2 | — | — | — | — |
| | B-3 | — | — | 0.1 | — |
| (C); | C-1 | 7 | — | — | — |
| | C-2 | — | — | 0.3 | — |
| | C-3 | — | — | — | 0.4 |
| | C-4 | — | — | — | — |
| | C-5 | — | — | — | — |
| | C-6 | — | — | — | — |
| | C-7 | — | — | — | — |
| | C-8 | — | — | — | — |
| Evaluation of thermoplastic | | | | | |
| resin composition | | | | | |
| Izod impact strength (J/m) | | 98 | 196 | 196 | 168 |
| Fluidity (g/10 min.) | | 15 | 21 | 20 | 18 |
| Thermal deformation | | 88 | 89 | 90 | 95 |
| temperature (° C.) | | | | | |
| Laser marking performance | | A | A | A | A |
| Letter color | | C | White | C | C |
| Comparative Example No. | | 5 | 6 | 7 | |
| Formulation (parts) | | | | | |
| (A); | A-1-(1) (ABS) | — | 30 | 30 | |
| | A-1-(2) (MBS) | — | — | — | |
| | A-1-(3) (MBS) | — | — | — | |
| | A-1-(4) (ABS) | — | — | — | |
| | A-2-(1) (AS) | — | 5 | 5 | |
| | A-2-(2) (MMA-ST-AN) | 10 | 45 | 45 | |
| | A-2-(3) (PNMA) | 90 | 20 | 20 | |
| (Meth)acrylic ester content | | 94 | 36 | 46 | |
| in component (A) (%) | | | | | |
| (B); | B-1 | — | 0.5 | 0.3 | |
| | B-2 | 0.5 | — | — | |
| | B-3 | — | — | — | |
| (C); | C-1 | — | — | — | |
| | C-2 | — | — | — | |
| | C-3 | — | — | — | |
| | C-4 | 0.3 | 0.3 | 0.2 | |
| | C-5 | — | — | — | |
| | C-6 | — | — | — | |
| | C-7 | — | — | — | |
| | C-8 | — | — | — | |
| Evaluation of thermoplastic | | | | | |
| resin composition | | | | | |
| Izod impact strength (J/m) | | 29 | 128 | 128 | |
| Fluidity (g/10 min.) | | 24 | 24 | 24 | |
| Thermal deformation | | 92 | 92 | 92 | |
| temperature (° C.) | | | | | |
| Laser marking performance | | A | A | A | |
| Letter color | | Green | Green | Red | |
| Example No. | | 8 | 9 | 10 | |
| Formulation (parts) | | | | | |
| (A); | A-1-(1) (ABS) | 30 | 30 | 30 | |
| | A-1-(2) (MBS) | — | — | — | |
| | A-1-(3) (MBS) | — | — | 70 | |
| | A-1-(4) (ABS) | — | — | — | |
| | A-2-(1) (AS) | — | 5 | — | |
| | A-2-(2) (MMA-ST-AN) | 45 | 45 | — | |
| | A-2-(3) (PNMA) | 30 | 20 | — | |
| (Meth)acrylic ester content | | 46 | 36 | 42 | |
| in component (A) (%) | | | | | |
| (B); | B-1 | 0.2 | — | 0.2 | |
| | B-2 | — | 0.2 | — | |
| | B-3 | — | 0.2 | — | |
| (C); | C-1 | 0.3 | — | — | |
| | C-2 | — | 0.3 | — | |
| | C-3 | — | — | 0.3 | |
| | C-4 | — | — | — | |
| | C-5 | — | — | — | |
| | C-6 | — | — | — | |
| | C-7 | — | — | — | |
| | C-8 | | | — | |

| | | | |
|---|---|---|---|
| Evaluation of thermoplastic | | | |
| resin composition | | | |
| Izod impact strength (J/m) | 98 | 128 | 137 |
| Fluidity (g/10 min.) | 28 | 22 | 22 |
| Thermal deformation | 88 | 92 | 90 |
| temperature (° C.) | | | |
| Laser marking performance | A | A | A |
| Letter color | Green | Yellow | Red |

What is claimed is:

1. A thermoplastic resin composition for laser marking capable of developing chromatic colors, comprising:
(A) 100 parts by weight of a thermoplastic resin comprising 1 to 100% by weight of a rubber-reinforced resin (A-1) obtained by polymerizing 95 to 30% by weight of at least one monomer (b) selected from the group consisting of aromatic vinyl compounds, vinyl cyanide compounds, (meth)acrylic esters, acid anhydride-based monomers and maleimide-based compounds in the presence of 5 to 70% by weight of a rubber-like polymer (a) {(a)+(b)=100% by weight}, and 99 to 0% by weight of a polymer (A-2) obtained by polymerizing at least one monomer selected from the group consisting of aromatic vinyl compounds, vinyl cyanide compounds, (meth)acrylic esters, acid anhydride-based monomers and maleimide-based compounds {(A-1)+(A-2)=100% by weight}, wherein a polymerized (meth)acrylic ester is contained in an amount of 30 to 70% by weight and the rubber-like polymer (a) is a mixture of at least two rubber-like polymers differing in particle size;
(B) 0.01 to 5 parts by weight of at least one black system compound selected from the group consisting of black iron oxide and titanium black; and
(C) 0.01 to 5 parts by weight of a dye and/or an organic pigment.

2. A thermoplastic resin composition according to claim 1, wherein the particle sizes of two rubber-like polymers are not less than 80 and not more than 180 nm, and more than 180 and not more than 480 nm.

3. A thermoplastic resin composition according to claim 2, wherein the particle sizes of two rubber-like polymers are 120 to 180 nm and 200 to 300 nm.

4. A thermoplastic resin composition according to claim 1, wherein the particle sizes of two rubber-like polymers are not less than 180 and not more than 480 nm, and more than 480 and not more than 1000 nm.

5. A thermoplastic resin composition according to claim 2, wherein the particle sizes of two rubber-like polymers are 200 to 300 and 500 to 800 nm.

6. A thermoplastic resin composition according to claim 1, wherein the rubber-like polymer (a) is at least one member selected from the group consisting of polybutadiene, butadiene-styrene copolymer, ethylene-propylene-(nonconjugated diene) copolymer, ethylene-butene-1-(nonconjugated diene) copolymer, hydrogenated diene-based polymers and silicone rubber.

7. A thermoplastic resin composition according to claim 1, wherein the rubber-like polymer (a) is silicone rubber containing 0.01 to 10% by weight of a graft crosslinking agent.

8. A thermoplastic resin composition according to claim 1, wherein the monomer (b) and the monomeric component of the polymer (A-2) are each at least one member selected from the group consisting of styrene, α-methystyrene, p-methylstyene, acrylonitirle, methyl methacrylate, butyl acrylate, maleic anhydride and N-phenylmaleimide.

9. A thermoplastic resin composition according to claim 1, wherein the monomer (b) contains 30 to 60% by weight of a maleimide-based compound.

10. A thermoplastic resin composition according to claim 1, wherein the graft ratio of the rubber-reinforced resin (A-1) is 10 to 150% by weight.

11. A thermoplastic resin composition according to claim 1, wherein the intrinsic viscosity [η] (measured in methyl ethyl ketone at 30° C.) of the matrix resin of the rubber-reinforced resin (A-1) is 0.1 to 1.0 dl/g.

12. A thermoplastic resin composition according to claim 1, wherein the intrinsic viscosity [η] (measured in methyl ethyl ketone at 30° C.) of the polymer (A-2) is 0.1 to 1.0 dl/g.

13. A thermoplastic resin composition according to claim 1, wherein the rubber-reinforced resin (A-1) is at least one type of resin selected from the group consisting of ABS resin, AES resin, ASA resin (polymer obtained by grafting AS resin to acrylic rubber) and ASS resin (polymer obtained by grafting AS resin to silicone rubber).

14. A thermoplastic resin composition according to claim 12, wherein the rubber content of the ABS resin or the AES resin is 20 to 65% by weight, its graft ratio is 40 to 150% by weight, and the intrinsic viscosity [η] of its matrix resin is 0.1 to 0.8 dl/g.

15. A thermoplastic resin composition according to claim 1, wherein the polymer (A-2) is at least one member selected from the group consisting of AS resin, ST-AN-MMA (AS resin in which methyl methacrylate (MMA) has been copolymerized) and PMMA resin.

16. A thermoplastic resin composition according to claim 15, wherein the amount of acrylonitrile copolymerized in the AS resin is 15 to 35% by weight, and the intrinsic viscosity [η] of said resin is 0.3 to 1.0 dl/g.

17. A thermoplastic resin composition according to claim 15, wherein the amount of MMA copolymerized in the ST-AN-MMA resin is 30 to 80% by weight, and the intrinsic viscosity [η] of said resin is 0.3 to 0.8 dl/g.

18. A thermoplastic resin composition according to claim 1, wherein at least one other type of resin selected from the group consisting of polyamide, polyethylene and polypropylene is contained in an amount of 1 to 150 parts by weight based on 100 parts by weight of the thermoplastic resin (A).

19. A thermoplastic resin composition according to claim 1, wherein a polyamide elastomer or a polyether ester amide is contained in an amount of 1 to 30 parts by weight based on 100 parts by weight of the thermoplastic resin (A).
